(19) United States
(12) Patent Application Publication
(10) Pub. No.: US 2010/0173732 A1
(43) Pub. Date: Jul. 8, 2010

(54) METHOD AND SYSTEM TO ASSIST IN THE TRAINING OF HIGH-LEVEL SPORTSMEN, NOTABLY PROFFESIONAL TENNIS PLAYERS

(76) Inventors: Daniel Vaniche, Paris (FR); Christian Miller, Le Blanc Mesnil (FR)

Correspondence Address: STITES & HARBISON PLLC, 1199 NORTH FAIRFAX STREET, SUITE 900, ALEXANDRIA, VA, 22314, US

(21) Appl. No.: 12/663,048

(22) PCT Filed: May 28, 2008
(86) PCT No.: PCT/FR2008/050928

§ 371 Date: Dec. 4, 2009

(30) Foreign Application Priority Data
Jun. 5, 2007 (FR) 0703997

(51) Int. Cl. A63B 69/00; G06F 19/00

(52) U.S. Cl. 473/422; 700/91

(57) ABSTRACT

The invention relates to an aid, put into practice by computers and videos, for improving the actions of athletes, comprising the stages:
obtaining (S1) from a system of filming an athlete's body, images of relative movements of parts of the body compared with a chosen reference frame which can advantageously be another part of the body;
filing (T4) the movements in a database in at least two categories comprising, on the one hand, the movements which allowed an effective action to be performed (S5) and on the other hand, the movements which did not allow an effective action to be performed (S6);
processing (T7, T9, S8) the contents of the database so as to define a limited set of parameters (a, ω, γ) essential for the performance of an effective action.
   which makes it possible to define (S10) training instructions for the athlete from just this restricted set of parameters.

The present invention relates to a computer-assisted aid for improving the actions of athletes, in particular professional tennis players.

A computer-assisted training technique is known, in particular from the document U.S. Pat. No. 5,947,742, which consists of comparing the actions of athletes to be trained with reference actions, for example to the standard actions of a well known coach. For example, an action such as a forehand in tennis of an athlete to be trained can be filmed in a first to sequence. An action of the same type (a forehand) performed by a reference such as a coach is filmed in a second sequence. The first and the second sequence are then projected onto the same screen for comparison.

However, within the framework of the present invention, it is sought to train high-level athletes, for example top-ranking players in the French professional tennis association, themselves constituting references.

The present invention aims to improve the situation.

To this end, a method is proposed, put into practice by computers, for assisting in improving sports actions, comprising the stages:
using a system of filming an athlete's body, the obtaining of images of the relative movements of parts of the body compared with a chosen reference frame which can advantageously be one or more other parts of the body;
filing the movements in a database in at least two categories comprising, on the one hand the movements which allowed an effective action to be performed and, on the other hand the movements which did not allow an effective action to be performed;
processing the contents of the database so as to define a limited set of parameters essential for the performance of an effective action, these parameters being chosen preferably from a position, a speed and an acceleration of a part of the body compared with the chosen reference frame;
   which makes it possible to define training instructions for the athlete simply from this limited set of parameters.

According to one of the advantages achieved by the present invention, it was observed that, for each athlete (at the very least for high-level athletes), only a few parameters were really significant for the performance of an optimal action. As a result, for a given action, the training instructions were able to be limited to the improving of just these few parameters.

According to another advantage achieved by the present invention, the training instructions which can result from the processing within the meaning of the invention are specific to the athlete and take account of his own physical abilities (flexibility, speed of movement, etc.) in performing a given action.

The present invention also relates to an installation for implementing the method and comprising elements such as a filming system, a central processing below.

It also relates to a computer program comprising instructions for implementing the method (in particular for processing the captured images, calculation of the movement parameters, storage in a database, statistical processing of the database) when they are executed by a processor of the central processing unit of the installation mentioned above.

Other features and advantages of the invention will become apparent when examining the detailed description below, and the attached drawings, in which:

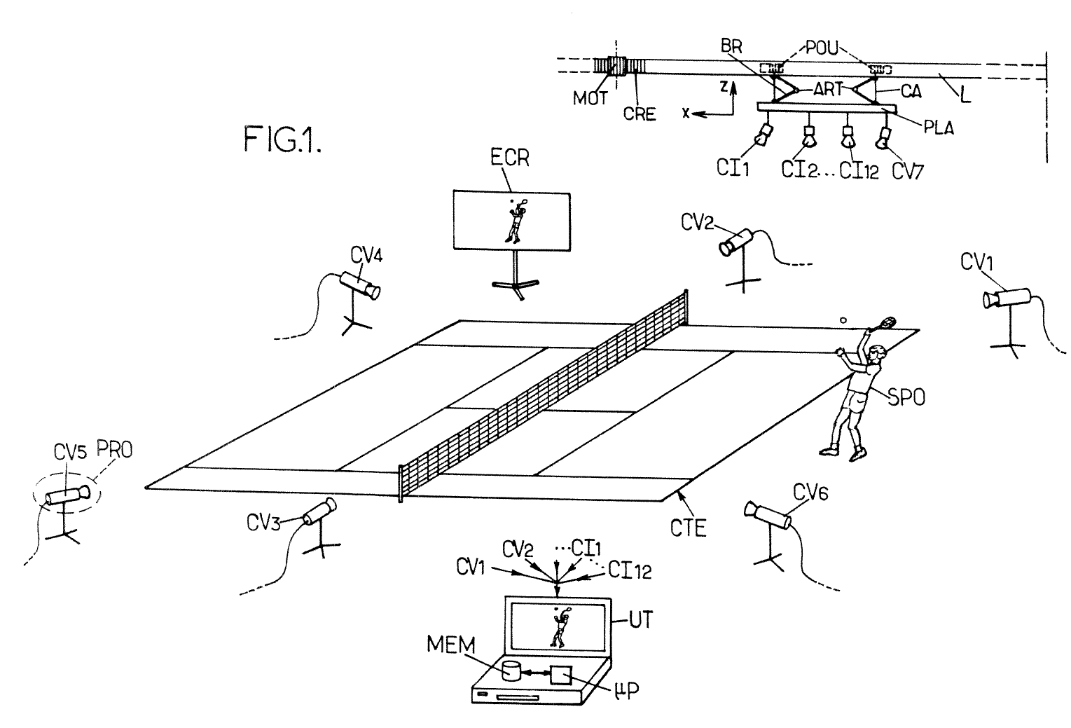

FIG. 1 schematically illustrates an installation for implementing the method within the meaning of the invention, in an embodiment;

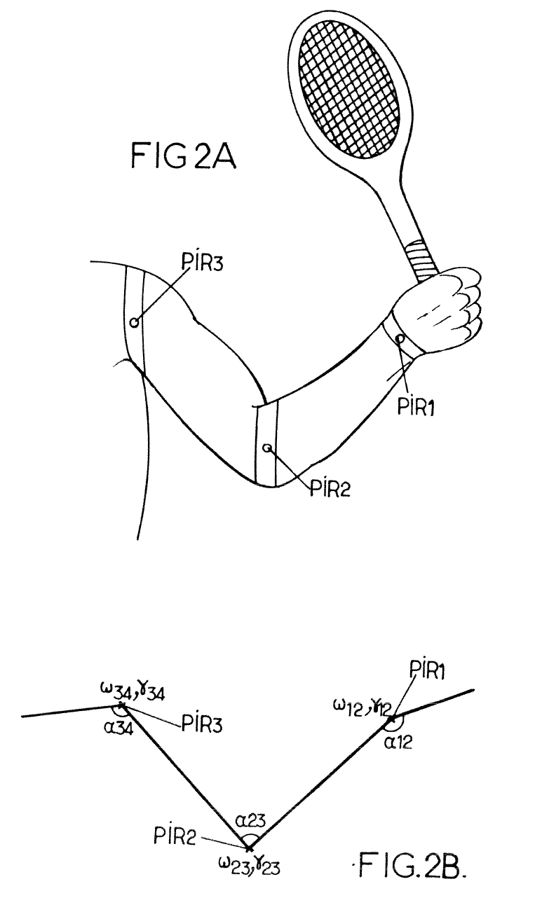

FIG. 2A shows the position of the reflective markers for obtaining morphological parameters of an athlete such as the position, speed and/or acceleration of body segments compared with a reference frame which can be another segment in the following description;

FIG. 2B schematically illustrates the wireframe of the arm represented in FIG. 2A; and

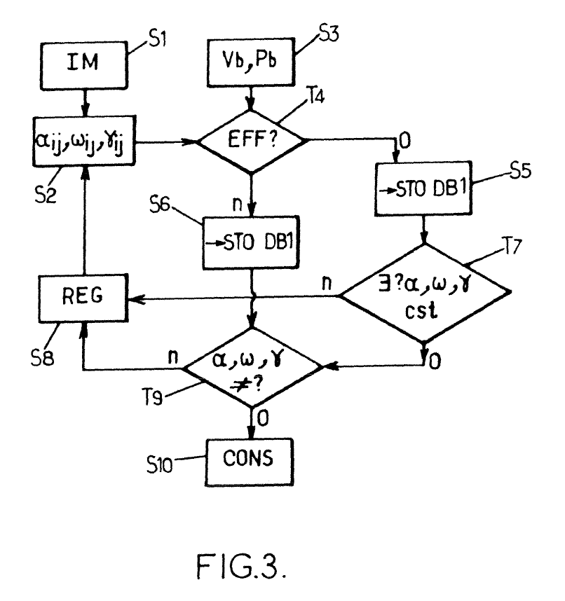

FIG. 3 schematically illustrates the stages of the method within the meaning of the invention, in an embodiment.

With reference to FIG. 1, firstly, an athlete SPO (a tennis player in the example described) is performing a typical action (a service, in the example shown in FIG. 1) on a sports track or playing surface CTE (such as a tennis court in the example shown in FIG. 1).

The athlete SPO is filmed by cameras sensitive to his movements (designated CI1, CI2 . . . CI12 in FIG. 1). By way of example, they can be cameras sensitive to a light emitted in the red/infrared (designated CI1, CI2 . . . CI12 in FIG. 1). With reference to FIG. 2A, the athlete wears markers which reflect red/infrared light (references PIR1, PIR2, PIR3) which then constitute points in a three-dimensional space, whose relative movements make it possible to characterize an overall action of the athlete. In FIG. 2A, for reasons of simplicity, only the arm of the athlete is shown. In reality, the athlete wears reflective markers preferably on all the articulation joints of the body (elbow, wrist, knee, etc.) and optionally on segments (forearm, arm, thighs, etc.), these markers being identifiable on the images captured by the cameras CI1 to CI12 of FIG. 1. Also, it can be advantageous to have at least one additional marker (not shown) on the racket held by the athlete, for example on its upper edge.

Preferably, each marker must be in the field of at least two cameras CI1, . . . CI12, in order to be located in the three-dimensional space, which justifies the provision of twelve cameras sensitive to the red/infrared. These cameras CI1, . . . CI12 are mounted on a motor-driven platform PLA and the motor MOT of this platform can drive the platform in translation along a horizontal axis x parallel to the tennis court CTE, as well as along an axis z vertical and perpendicular to the tennis court CTE. Preferably, the platform PLA is placed above a centre axis of the tennis court, which extends from the service area (behind the base line of the court) to the net. Thus, several actions of tennis players can be analysed, such as the service, forehand/backhand shots hit from the back of the court, volleys (smash, stop or other). To this end, the platform can move on rails L parallel to the x axis. It should be noted that a conventional solution, consisting of having one or more cameras carried by cables, is not applicable here in view of the heavy weight represented by the cameras CI1, . . . CI12 (2.5 kg each). As a result, the structure on which these cameras rest is rigid. For example, the rails L are rigid, preferably made of metal. Moreover, as the cameras CI1, . . . CI12 are intended to reconstruct a three-dimensional image of the relative positions of the markers PIR1, PIR2, PIR3 worn by the player, it is preferable that the positions of cameras CI1, . . . CI12 are fixed in relation to each other. As a result, the platform PLA must not have areas where twisting under the weight of the cameras is possible. To achieve this, the platform is in the form of a square formed by four metal tubes, each approximately 60 mm in diameter and 12 metres long.

For the vertical displacement (along the z axis), the platform PLA is for example supported by cables CZ connected to motor-driven pinions POU. However, the platform PLA is also connected to articulated arms BR which can advantageously comprise, for example at the level of the articulations ART, a gearing which ensures that the platform moves with precision to within a few centimetres. Similarly, the horizontal displacement (along the x axis) of the platform PLA is carried out using motor-driven pinions MOT engaging with a rack CRE integral with the platform, which also ensures a movement accurate to within a centimetre.

The cameras CI1, . . . CI12 sensitive to red/infrared are connected to a processing unit UT which comprises software which makes it possible in particular to determine the relative positions of the reflective markers arranged on the body of the athlete, so that the athlete can be represented in three-dimensional space by a wireframe as shown in FIG. 2B.

More particularly, software of the processing unit UT makes it possible, by recognition of the shapes of the reflective markers PIR1, PIR2, PIR3 on the images captured by the cameras CI1 to CI12, to determine the respective positions of the markers over time and thus show a development over time of a wireframe connecting the points PIR1, PIR2, PIR3 of FIG. 2B. This wireframe thus represents the movements of the athlete over time, in a three-dimensional space. This technique of computerized reconstruction of movements of an individual represented by a wireframe changing in a three-dimensional space is known in particular in modelling techniques for carrying out virtual movements, for example in computer games.

FIG. 2B represents only the wireframe of the arm shown in FIG. 2A. In practice, the wireframe of the whole of the athlete's body is obtained. In the example shown in FIG. 2B, from the positions of the reflective markers PIR1, PIR2, PIR3, it is possible to determiner the exact positions of the segments forming the upper limb of the athlete, so as to define:
the angles αᵢⱼ formed between each segment of the upper limb (or more generally, adjacent segments of the athlete's body);
the angular speeds ωᵢⱼ of rotation of a segment i in comparison with an adjacent segment j (for example the speed of rotation ω₂₃) of the arm in relation to the forearm;
the angular acceleration γᵢⱼ of a segment of the body compared with an adjacent segment (around a joint).

Moreover, it proved more practical, to follow the movements of an athlete during the performance of an action, to capture and display a real image of the athlete and his wireframe synchronized, or even superimposed, on the same screen ECR. This embodiment makes it possible to improve the ergonomics of the training aid proposed by the present invention. To this end, seven cameras CV1 . . . CV7 are arranged around the tennis court (FIG. 1) of which one camera CV7 is preferably located on the platform PLA, with the cameras CI1 . . . CI12 which are sensitive to red/infrared radiation. Thus, the signals from the seven cameras CV1 . . . CV7 and the signals from the twelve cameras CI1, . . . CI12 are processed by the processing unit UT to carry out this synchronisation with and/or this superimposition of the wireframe on the real images captured. The athlete SPO can display his action with the movements shown in the wireframe displayed or superimposed on the real image captured by the cameras CV1 to CV7, on a display screen ECR arranged for example facing him.

In order to capture the images of the athlete from the cameras CV1 to CV7, it is convenient to position at least some of these cameras substantially at the same level as the athlete (cameras designated CV1 to CV6 in the example represented in FIG. 1). The problem then arises of balls possibly hitting the cameras CV1 to CV6. To solve this problem, protective bubbles PRO are advantageously provided, shaped approximately spherically with for example a flattened area in front of the lens so as not to optically deform the captured images, these bubbles being made of a transparent material of the plexiglas type or similar.

Reference is now made to FIG. 3, to describe the stages of the method within the meaning of the invention, in a particular embodiment. In stage S1, the filmed sequences from the cameras CI1, . . . CI12, during a given action of the athlete SPO are obtained. In stage S2 are taken therefrom, the parameters of angular position αᵢⱼ, angular speed ωᵢⱼ and angular acceleration γᵢⱼ of each segment compared with a reference frame which, in the example described, is an adjacent segment. By way of a variant, the reference frame could, for example, be a fixed point on the ground, or also the tennis ball.

Moreover, in stage S3, data relating to the efficiency of an action are obtained. For example, this can involve the speed of the tennis ball V_{b} and its position P_{b} when it hits the ground (distance(s) compared with one or two lines of the tennis court for example). Of course, another criterion can also be the initial intention of the athlete to actually land the ball at this position P_{b}. These criteria thus make it possible to define the effectiveness of the action and in test T4, if the action was effective, the data relating to the parameters αᵢⱼ, ωᵢⱼ and γᵢⱼ are stored in a database DB2 in stage S5. On the other hand, if the action was not effective (end n of test T4), the parameters αᵢⱼ, ωᵢⱼ and γᵢⱼ are stored in another database DB in stage S6.

For example, to objectively determine the speed and the position of the ball at the moment of impact in stage S3, it can be advantageous to refer to an additional camera which, by recognizing the shape of the ball, determines these parameters of ball speed and position.

The test T7 then consists of determining the parameters αⱼ, ωᵢⱼ and γᵢⱼ which are constant subject to an error threshold in the database DB2 and which allowed the performance of an effective action (test T7). If no correlation was found with the parameters αᵢⱼ, ωᵢⱼ and γᵢⱼ (arrow n at the end of test T7), new parameters can be defined, for position, angular speed and/or angular acceleration between segments of the body which are not adjacent (for example between the hand and the arm of the athlete, or also an angular deviation between the feet of the athlete, or other) and significant parameters for the performance of an effective action continue to be sought. By way of a variant or in addition, it is also possible to increase the tolerance as regards the effectiveness of the action (for example by assuming lower impact speeds of balls or a greater deviation between the point of impact and the ground line).

To this end a stage S8 is provided for redefining the rules which make it possible to choose parameters which are more significant in relation to the effectiveness or the non-effectiveness of an action.

On the other hand, if parameters αᵢⱼ, ωᵢⱼ and γᵢⱼ were found substantially constant for the performance of an effective action (arrow o at the end of test T7), it is also verified whether these parameters have significantly different values in the database relating to ineffective actions DB1 (test T9). If the values of these parameters are significantly different in the database relating to ineffective actions, they are considered to be essential for the performance of an effective action (arrow o at the end of test T9), which makes it possible to define training instructions in stage S10. For greater clarity, in FIG. 3, the candidate parameters which can be selected at the end of test T7 and/or T9 are marked α, ω and γ, without their indices.

For example, if the important parameters α, ω and γ, which are adopted for the effectiveness of a backhand are:
the angle formed at the knee of the supporting leg;
the angle formed at the joint between the arm and the shoulder of the arm holding the racket;
the angular acceleration of this arm at the elbow;
the angular speed at the joint between this arm and the shoulder; or other,
   the training instructions defined in stage S10 will mean an emphasis on these morphological data such that the athlete has to observe them each time he plays a backhand.

On the other hand, if the parameters taken from database DB1 (ineffective action) do not have values significantly different from those determined at the end of test T7 (arrow n at the end of test T9), there is a return to stage S8 to define new parameters, in particular of positions, speeds or accelerations of segments of the body compared with other segments which are not necessarily adjacent.

Of course, stages T7, T9 and S8 can be conducted by sophisticated means of statistical analysis, for example an artificial neural network capable of operating on the database DB2 of the effective actions, as a learning database and to analyse the contents of the database DB1 relating to the ineffective actions in order to obtain the most significant parameters for the performance of an effective action.

Of course, the processing unit comprises in the normal way a working memory MEM and a processor μP for carrying out the processing operations described above, in particular from the analysis of the captured images to the delivery of the training instructions. The processor unit can also be capable of controlling the displacements of the platform PLA by a computerized control of the motors MOT. In more generic terms, the processor unit UT comprises:
the memory MEM which can also be used to store images of movements in the database DB1, DB2, which are then filed in at least two categories comprising, one the one hand, the movements which allowed an effective action to be performed (DB2) and, on the to other hand, the movements which did not allow an effective action to be performed (DB1); and
a processor μP for processing the contents of the database so as to define a limited set of parameters essential for the performance of an effective action.

Of course, the present invention is not limited to the embodiment described above by way of example; it extends to other variants.

Thus it will be understood that the reflective markers PIR1, PIR2, PIR3 described above by way of example are amenable to variants. It may happen that the fixing of these markers on the body (on an elastic band surrounding a limb of the body) restricts the athlete performing an action. In an advantageous variant, patches of a marker, reflecting a red/infrared light of the same type, can be envisaged, these patches being attached to special clothing, for example black and close-fitting. The number of cameras given above with reference to FIG. 1, although advantageous, is amenable to variants depending on the applications considered. Moreover, the present invention is not limited to improvements for tennis players. Tests performed also showed that the method was advantageous for determining essential parameters for training sprinters, in particular at the start of a race. Typically, a limited set of parameters can also be extracted to optimize a sprinter's start.

Moreover, the parameters shown in FIG. 2B of angular position, angular speed and angular acceleration are described by way of example only. As a variant, there could very well be parameters such as, in particular, speeds and/or accelerations, in translation, of certain parts of the body compared with a chosen reference frame.

Of course, it is possible to refine the training instructions by increasing for example the number of databases constructed in relation to the effectiveness of the action. Typically, more than two databases DB1 and DB2 can be provided. The set of the constructed databases can then make it possible to characterize, for example, the accuracy of the action compared to the position of the ball at the moment of impact and/or the effectiveness of the action compared to the speed of the ball. Thus it will be understood that the more exhaustive the contents of an overall database and the more separated into different categories of effectiveness, the more accurate can be the choice of the parameters enabling the athlete to be trained.

1. Method, performed by computer means, for assisting in improving sports actions, comprising the steps:
obtaining, from a system of filming an athlete's body, images of relative movements of parts of the body compared with a chosen reference frame;
filing the movements in a database in at least two categories comprising, on the one hand, the movements which allowed an effective action to be performed and on the other hand, the movements which did not allow an effective action to be performed;
processing the contents of the database so as to define a limited set of parameters essential for the performance of an effective action.

2. Method according to claim 1, wherein said parameters are chosen from a position, a speed and an acceleration of a part of the body in relation to the chosen reference frame.

3. Method according to claim 2, wherein said parameters are chosen from an angular position, speed and acceleration of adjacent segments of the body linked by a joint.

4. Method according to claim 1, wherein said chosen reference frame is one or more other parts of the body.

5. Method according to claim 1, comprising a later step of defining training instructions for the athlete from said limited set of parameters.

6. Method according to claim 1, wherein the filming system comprises a plurality of cameras set up to film the action for a three-dimensional wireframe reconstruction of the athlete, from which said parameters are deduced.

7. Method according to claim 6, wherein the filming system also comprises at least one additional camera for filming a sequence of real images of the athlete performing the action, and wherein a synchronized display of the real images and the wireframe reconstruction of the athlete are displayed on the same screen.

8. Method according to claim 1, wherein a statistical processing of the contents of the database is applied to determine the most significant parameters according to at least one criterion of effectiveness of the action.

9. Method according to claim 8, wherein the action is a tennis action and the effectiveness criterion comprises at least the speed and/or the position of the ball when it hits the ground compared with at least one line of a tennis court.

10. Installation for putting into practice the method according to claim 1, comprising:
a system for filming the body of an athlete in order to obtain images of relative movements of parts of the body compared with a chosen reference frame during an action of the athlete; and
a processor unit comprising:
a memory for storing a database of images of movements, and listed in at least two categories comprising, on the one hand, the movements which allowed an effective action to be performed and, on the other hand, the movements which did not allow an effective action to be performed; and
a processor for processing the contents of the database so as to define a limited set of parameters essential for the performance of an effective action.

11. Installation according to claim 10, wherein the filming system comprises:
a plurality of markers reflecting red/infrared light arranged on selected parts of the body of the athlete, and
a plurality of cameras sensitive to red/infrared light and set up to film the action for a three-dimensional wireframe reconstruction of the athlete.

12. Installation according to claim 11, wherein each marker is in the field of at least two cameras sensitive to red/infrared light.

13. Installation according to claim 10, wherein at least part of the filming system is arranged on a mobile platform above a surface on which the athlete moves, at least:
along an axis parallel to said surface,
along an axis perpendicular to said surface.

14. Installation according to claim 13, wherein the platform is moved by at least one motor connected to a gearing mechanism.

15. Installation according to claim 11, wherein the processor unit is programmed to:
deliver a three-dimensional wireframe reconstruction of the athlete from the images captured by the cameras sensitive to red/infrared light, and
deduce parameters from said wireframe reconstruction, from a position, a speed and an acceleration of a part of the body compared with a chosen reference frame;
and in that the processor unit is programmed to extract from said parameters from a position, a speed and an acceleration, a limited set of parameters essential for the performance of an effective action.

16. Installation according to claim 15, wherein the filming system also comprises at least one additional camera for filming a sequence of real images of the athlete performing the action, and wherein the processor unit is programmed to display in synchronization the real images and the wireframe reconstruction of the athlete on the same screen.

17. Installation according to claim 16, wherein the additional camera is at the same level as the athlete and protected by a substantially spherical transparent casing.

18. Computer program intended to be stored in a memory of a processor unit of an installation according to claim 1, comprising instructions for putting the method into practice according to claim 1 when it is run by a processor of said processor unit.
